(19) United States
(12) Patent Application Publication
(10) Pub. No.: US 2026/0058176 A1
(43) Pub. Date: Feb. 26, 2026

(54) FUEL CELL GAS CORRECTION SYSTEM FOR BLENDED GAS FUELS AND DUAL FUEL OPERATION

(71) Applicant: Bloom Energy Corporation, San Jose, CA (US)

(72) Inventors: Ali ZARGARI, Santa Clara, CA (US); Jayakumar KRISHNADASS, Sunnyvale, CA (US); Archana BHALERAO, Pleasanton, CA (US); Adrian ONG, Clayton, CA (US)

(21) Appl. No.: 19/302,333

(22) Filed: Aug. 18, 2025

Related U.S. Application Data
(60) Provisional application No. 63/684,979, filed on Aug. 20, 2024.

(51) Int. Cl. H01M 8/0444; H01M 8/04089; H01M 8/0438; H01M 8/04746; H01M 8/04858

(52) U.S. Cl. CPC H01M 8/0444; H01M 8/04089; H01M 8/04425; H01M 8/04776; H01M 8/0488; H01M 8/0491

(57) ABSTRACT

A method of operating a fuel cell system includes providing a fuel to a fuel cell system, purifying the fuel to generate a purified fuel, detecting a fuel composition of purified fuel, determining a fuel mass flow rate of the purified fuel based on the detected fuel composition, and providing the purified fuel to a stack of fuel cells at the determined mass flow rate.

### FIELD

Aspects of this disclosure relate to fuel cell systems and methods, and more particularly, to a fuel cell system including a gas analyzer and a method of controlling the fuel cell system.

### BACKGROUND

Fuel cells, such as solid oxide fuel cells, are electrochemical devices which can convert energy stored in fuels to electrical energy with high efficiencies. High temperature fuel cells include solid oxide and molten carbonate fuel cells. These fuel cells may operate using hydrogen and/or hydrocarbon fuels. There are classes of fuel cells, such as solid oxide regenerative fuel cells, that also allow reversed operation, such that oxidized fuel can be reduced back to unoxidized fuel using electrical energy as an input.

### SUMMARY

According to various embodiments, a fuel cell system comprises a fuel inlet configured to receive a fuel from a fuel source; a fuel processor configured to remove contaminants from the fuel provided to the fuel inlet; a gas analyzer configured to detect fuel composition of the fuel output from the fuel processor; a stack of fuel cells configured to generate electricity using the fuel output from the fuel processor; a mass flow controller (MFC) configured to control a mass flow rate of the fuel output from the fuel processor to the stack; and a system controller configured to control the MFC based on the detected fuel composition.

According to various embodiments, a method of operating a fuel cell system includes providing a fuel to a fuel cell system, purifying the fuel to generate a purified fuel, detecting a fuel composition of purified fuel, determining a fuel mass flow rate of the purified fuel based on the detected fuel composition, and providing the purified fuel to a stack of fuel cells at the determined mass flow rate.

### BRIEF DESCRIPTION OF THE DRAWINGS

The accompanying drawings, which are incorporated herein and constitute part of this specification, illustrate example embodiments of the disclosure, and together with the general description given above and the detailed description given below, serve to explain the features of the disclosure.

FIG. 1 is a 3D projection of a modular fuel cell system 10, according to various embodiments of the present disclosure.

FIG. 2A is a schematic view showing fuel flow paths through the system 10 of FIG. 1, and FIG. 2B is a schematic view showing components in and connected to a power module of the system of FIG. 2A.

FIG. 3A is a schematic view showing fuel flow paths through an alternative fuel cell system, and FIG. 3B is a schematic view showing components in and connected to a power module of the system of FIG. 3A.

FIG. 4 is a flow diagram illustrating a method of operating a fuel cell system, according to one embodiment of the present disclosure.

FIG. 5 is a flow diagram illustrating a method of operating a fuel cell system, according to another embodiment of the present disclosure.

### DETAILED DESCRIPTION

The various embodiments are described in detail with reference to the accompanying drawings. Wherever possible, the same reference numbers will be used throughout the drawings to refer to the same or like parts. References made to particular examples and implementations are for illustrative purposes and are not intended to limit the scope of the invention or the claims.

Solid oxide fuel cell (SOFC) systems can operate using a variety of hydrogen-containing fuels, such as hydrocarbon fuels (e.g., methane, propane, butane, natural gas comprising primarily methane, etc.), pure hydrogen (H₂), or even ammonia. Currently, gas utilities provide hydrocarbon fuels, such as methane or methane/propane blends (peak shaving gas). However, in order to reduce carbon emissions, gas utilities are planning to transition to providing fuels having a lower carbon content. For example, gas utilities are considering providing natural gas/hydrogen (H₂) blends and/or pure hydrogen (H₂).

However, the energy density of a blended gas depends on the hydrogen to hydrocarbon ratio of the gas, given the relatively low energy density of hydrogen. As such, the fuel mass flow requirements of an SOFC system may vary depending on the composition and/or energy density of the fuel provided thereto. For example, a higher hydrogen content may require a higher mass flow, in order to prevent cell fuel starvation.

In addition, pipeline gas generally includes sulfur compounds, either as contaminants or as additives used to facilitate leak detection. As such, SOFC systems generally include fuel processors including desulfurization beds, in order to protect catalysts used in the fuel cell system from deactivation by sulfur species. However, hydrogen adsorption and desorption within desulfurization beds may also affect fuel composition.

Embodiments of the present disclosure provide fuel cell systems that utilize blended fuels or which sequentially operate on different fuels while limiting damage to system components.

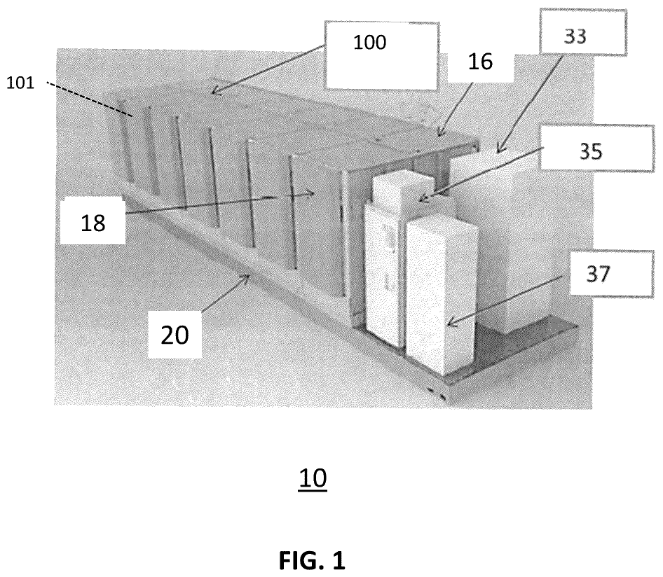

FIG. 1 is 3D projection of a modular fuel cell system 10, according to various embodiments of the present disclosure. Referring to FIG. 1, the system 10 may include various modules disposed on a common base 20. For example, the system 10 may include one or more power modules 100, a fuel processing module 16, a power conditioning module 18, and optional ancillary modules, such as a water distribution module 33, a telemetry module 35, and a power distribution system module 37. Alternatively, common ancillary modules may be provided for large scale power generation systems containing plural fuel cell systems 10. In this case, the ancillary modules are provided separately from each fuel cell system 10. Each module may include a cabinet 101 in which module components are disposed. For example, the power modules 100 may be provided in one or more rows, such as two rows, on the common base 20. The common base 20 may comprise a concrete pad and/or a metal skid containing at least one channel therein for various fluid conduits and/or electrical connections.

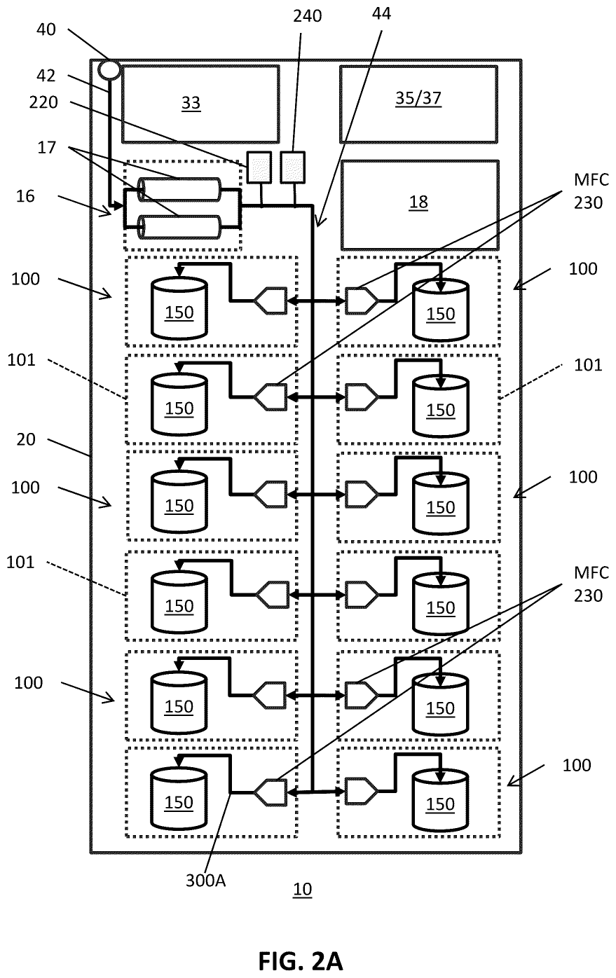

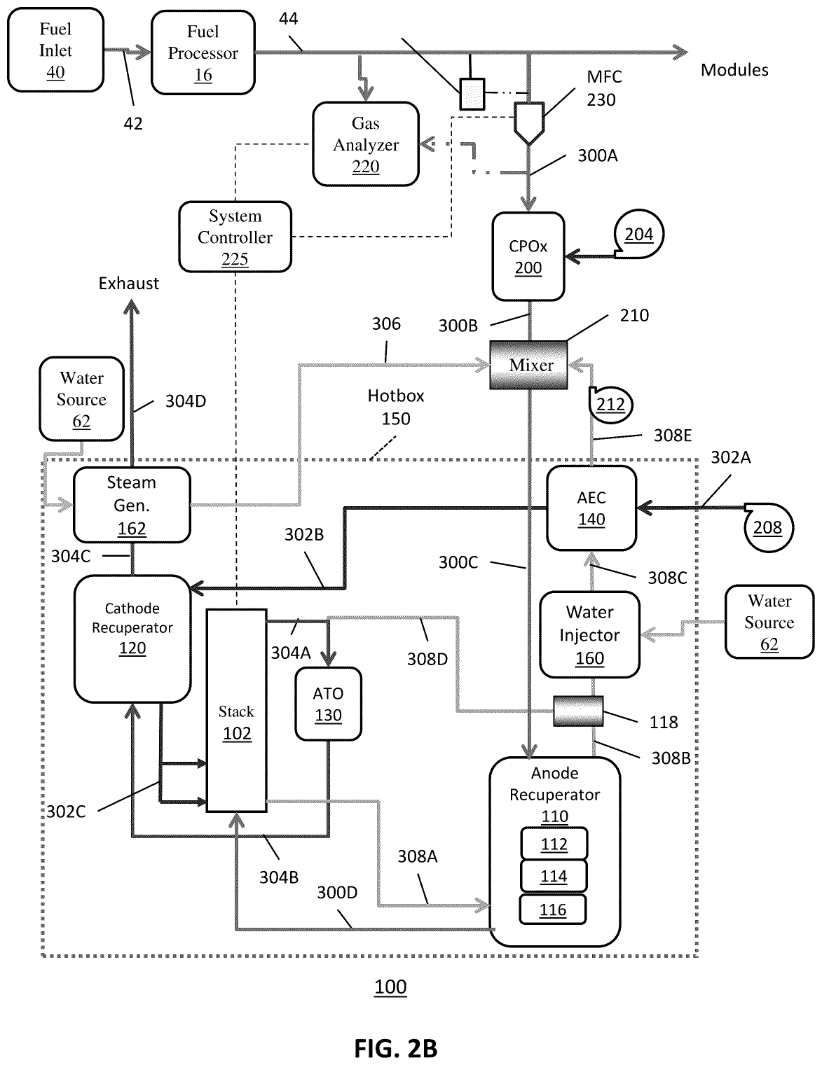

As discussed in detail with respect to FIGS. 2A and 2B, the power modules 100 may include a hotbox 150 comprising SOFC stacks that generate electrical power using fuel and/or water provided thereto through conduits in the base 20. The power module cabinets 101 may house the hotboxes 150 and other system components. The power conditioning module 18 may operate to convert DC power received from the power modules 100 into AC power that is output from the system 10. For example, the power conditioning module 18 may include DC/DC and DC/AC converters (as described in U.S. Pat. No. 7,705,490, incorporated herein by reference in its entirety), electrical connectors for AC power output to the grid, circuits for managing electrical transients, and a system controller 225 (e.g., a computer or dedicated control logic device or circuit). The power conditioning module 18 may be designed to convert DC power from the fuel cell modules to different AC voltages and frequencies. Designs for 208V, 60 Hz; 480V, 60 Hz; 415V, 50 Hz and other common voltages and frequencies may be provided.

The fuel processing module 16 may include adsorption beds 17 configured to remove sulfur species and/or other contaminants from the fuel provided thereto. As such, the fuel processing module 16 may provide a purified fuel to the power modules 100.

The optional water distribution module 33 deionizes and/or filters input water and thereby provides deionized water for the power modules 100. The optional power distribution system module 37 may include one or more circuit breakers and/or relays between the fuel cell system power output from the power conditioning module 18 and electrical power consumer.

The optional telemetry module 35 may include a transceiver that provides system process information to a location remote from the system (e.g., central control room located distal from the fuel cell system location) and allows remote control of the power modules 100 and fuel cell system 10. The system process information may include one or more of electricity production, electricity consumption, fuel consumption, fuel composition, water consumption, and fuel cell stack temperature. The telemetry module 35 may communicate to the remote location wirelessly or via wires, such as though cable or telephone wire. In some embodiments, the telemetry module 35 may communicate with a control center or device via the Internet. In an alternative embodiment, the telemetry module 35 rather than the power conditioning module 18 may include the system controller 225.

The base 20 may be formed of concrete and/or metal and may include plumbing and electrical components to fluidly and electrically connects the modules. For example, the base 20 may include a fuel inlet 40 that may be fluidly connected to a fuel source, such as a utility gas line. The fuel inlet 40 may be connected to an inlet of the fuel processor 16 by a fuel inlet conduit 42.

The base 20 may include a fuel manifold 44 (e.g., one or more fuel inlet conduits) that fluidly connects an outlet of the fuel processor 16 to fuel inlets of the power modules 100. The fuel manifold 44 may be at least partially disposed in (e.g., contained within) the base 20. The base 20 may also include water conduits (not shown) connecting to the power modules 100 to the water distribution module 33 or to the municipal water supply. The base 20 may also include electrical wiring and/or bus bars (not shown) to electrically connect the power modules 100 to the power conditioning module 18, the power distribution system module 37 (if present) and/or the telemetry module 35 (if present).

The system 10 may also include a gas analyzer 220 and an optional fuel pressure sensor 240 fluidly connected to the fuel manifold 44. As discussed in detail below, the gas analyzer 220 may be configured to detect fuel composition and the fuel pressure sensor 240 may be configured to detect a fuel pressure in the fuel manifold 44.

FIG. 2A is a schematic view showing fuel flow through the system 10 of FIG. 1, and FIG. 2B is a schematic view showing components of and connections to a power module 100 of FIG. 2A. Referring to FIGS. 1, 2A, and 2B, the power module 100 includes a hotbox 150 and various system components disposed therein or adjacent thereto.

The hotbox 150 may contain one or more fuel cell stacks 102, such as a solid oxide fuel cell stacks (where one solid oxide fuel cell of the stack contains a ceramic electrolyte, such as yttria stabilized zirconia (YSZ) or scandia stabilized zirconia (SSZ), an anode electrode, such as a nickel-YSZ or Ni-SSZ cermet, and a cathode electrode, such as lanthanum strontium manganite (LSM)). Other fuel cell types, such as PEM, molten carbonate, phosphoric acid, etc. may also be used. The stacks 102 may be arranged over each other to form a column and a plurality of fuel cell columns may be contained in a single hotbox. Alternatively, a fuel cell column may comprise only one fuel cell stack 102.

The fuel cell stacks 102 may include externally and/or internally manifolded stacks. For example, the stacks may be internally manifolded for fuel and air with fuel and air risers extending through openings in the fuel cell layers and/or in the interconnect plates between the fuel cells.

Alternatively, the fuel cell stacks may be internally manifolded for fuel and externally manifolded for air, where only the fuel inlet and exhaust risers extend through openings in the fuel cell layers and/or in the interconnect plates between the fuel cells, as described in U.S. Pat. No. 7,713,649, which is incorporated herein by reference in its entirety. The fuel cells may have a cross flow (where air and fuel flow roughly perpendicular to each other on opposite sides of the electrolyte in each fuel cell), counter flow parallel (where air and fuel flow roughly parallel to each other but in opposite directions on opposite sides of the electrolyte in each fuel cell) or co-flow parallel (where air and fuel flow roughly parallel to each other in the same direction on opposite sides of the electrolyte in each fuel cell) configuration.

The hotbox 150 may also contain an anode recuperator 110, a cathode recuperator 120, an anode tail gas oxidizer (ATO) 130, an anode exhaust cooler 140, and a splitter 118. The hotbox 150 may also include a water injector 160 or a steam generator 162.

The power module 100 may also include a catalytic partial oxidation (CPOx) reactor 200, a mixer 210, a CPOx blower 204 (e.g., air blower), a system blower 208 (e.g., main air blower), and a fuel recycle blower 212, which may be disposed outside of the hotbox 150. However, the present disclosure is not limited to any particular location for each of the components with respect to the hotbox 150.

The CPOx reactor 200 receives a fuel inlet stream output from the fuel processor 16 via the fuel manifold 44 and fuel conduit 300A. The CPOx blower 204 may provide air to the CPOx reactor 202. The CPOx blower 204 generally operates during startup and is usually not operated during steady-state system operation. During a cold startup of the system 10, the fuel is partially oxidized in the CPOx reactor 200 by injection of air from the CPOx blower 204.

The fuel and/or air may be provided from the CPOx reactor 200 through a fuel conduit 300B to the mixer 210. The fuel inlet stream may be mixed in the mixer 210 with steam and/or anode exhaust stream provided to the mixer 210 by recycling conduit 308E. The fuel inlet stream then flows from the mixer 210 to the anode recuperator 110 through a fuel conduit 300C. The fuel inlet stream is heated is the anode recuperator 110 by hot anode exhaust emitted from the stack 102 via recycling conduit 308A. The fuel inlet stream then flows from the anode recuperator 110 to the stack 102 through a fuel conduit 300D.

The main air blower 208 may be configured to provide an air stream (e.g., air inlet stream) to the anode exhaust cooler 140 through air conduit 302A. Air flows from the anode exhaust cooler 140 to the cathode recuperator through air conduit 302B. The air flows from the cathode recuperator 120 to the stack 102 through air conduit 302C.

The anode exhaust generated in the stack 102 is provided to the anode recuperator 110 through recycling conduit 308A. The anode exhaust may contain unreacted fuel. The anode exhaust may also be referred to herein as fuel exhaust. The anode exhaust may be provided from the anode recuperator 110 to a splitter 118 by a recycling conduit 308B. A first portion of the anode exhaust may be provided from the splitter 118 to the anode exhaust cooler 140 by a recycling conduit 308C. A second portion of the anode exhaust may be provided from the splitter 118 to the ATO 130 by a recycling conduit 308D. The second portion of the anode exhaust is oxidized in the ATO 130 by the stack 102 cathode exhaust. Anode exhaust may be provided from the anode exhaust cooler 140 to mixer 210 by the recycling conduit 308E. The fuel recycle blower 212 may be configured to move anode exhaust though recycling conduit 308E.

The cathode (e.g., air) exhaust generated in the stack 102 flows to the ATO 130 through an exhaust conduit 304A. Cathode exhaust (i.e., the ATO exhaust generated in the ATO 130) flows from the ATO 130 to the cathode recuperator 120 through an exhaust conduit 304B. If the power module 100 includes a steam generator 162, the ATO exhaust flows from the cathode recuperator 120 to the steam generator 162 through an exhaust conduit 304C. The ATO exhaust flows from the steam generator 162 and out of the hotbox 150 through exhaust conduit 304D.

Water flows from a water source 62, such as a water pipe disposed in the base 20, to the water injector 160 and/or to the optional steam generator 162. The water injector 160 may be used to inject water into the anode exhaust stream, where the water is vaporized to generate steam that increases the water content of the anode exhaust. The steam generator 162 converts the water into steam using heat from the ATO exhaust provided by exhaust conduit 304C. Steam is provided from the steam generator 162 to the mixer 210 through water conduit 306. Alternatively, if desired, the steam may be provided directly into the fuel inlet stream and/or the anode exhaust stream may be provided directly into the fuel inlet stream followed by humidification of the combined fuel streams. The mixer 210 is configured to mix the steam with anode exhaust and fuel. This fuel mixture may then be heated in the anode recuperator 110, before being provided to the stack 102.

The power module 100 may also include one or more fuel catalysts disposed in the anode recuperator 110, such as an oxidation catalyst 112, a hydrogenation catalyst 114, and a reforming catalyst 116, which may be configured to catalyze various fuel reactions. In various embodiments, the catalysts 112, 114, 116 may include a metallic/ceramic foam with a catalytic layer (e.g., palladium, nickel and/or rhodium), a metallic/ceramic foam without a catalytic layer where the base metal of the foam is catalytically active (e.g., nickel), a large number of coiled wires with a catalytic layer, a packed bed of catalyst pellets, or any combination thereof.

The heated fuel enters the anode recuperator 110 and flows through the oxidation catalyst 112. The oxidation catalyst 112 may be configured to remove free oxygen without excessive reformation of methane. For example, the oxidation catalyst 112 may facilitate the reaction of oxygen with H₂, CO, and/or other natural gas components in the fuel. The removal of free oxygen prevents or reduces the oxidation of a reforming catalyst 116. For example, the oxidation catalyst 112 may be configured to reform less than about 20%, such as less than about 18%, less than about 15%, less than about 12%, or less than about 10% of the methane and/or other higher hydrocarbons included in the fuel.

The fuel may then flow into a hydrogenation catalyst 114. The hydrogenation catalyst 114 may be a catalytic reactor configured to combine unsaturated hydrocarbons, such as ethylene and/or propylene (alkenes), with available hydrogen in the fuel stream, resulting in saturated hydrocarbons, such as ethane and propane or other alkanes.

The fuel then flows into a reforming catalyst 116. The reforming catalyst 116 may be a catalytic reactor configured to partially reform the fuel before the fuel is delivered to the stack 102. The reformation reaction is endothermic (e.g., a steam methane reformation (SMR) reaction) and may operate to cool the fuel prior to feeding the stack.

### Mixed Fuel Operations

The power module 100 may be configured to operate using a hydrocarbon fuel, hydrogen (H₂), or a blended fuel including a hydrocarbon fuel (e.g., natural gas, methane, etc.) and hydrogen. In particular, the power module 100 and/or the fuel cell system 10 may include components configured to detect the composition of a fuel provided to the fuel cell system 10 and to adjust power module operation based on the detected fuel composition.

For example, the power module 100 and/or system 10 may include a system controller 225 and a mass flow controller (MFC) 230. The system controller 225 may include a central processing unit configured to execute stored instructions and a memory configured to store the instructions. The system controller 225 may be wired or wirelessly connected to various system components, such as the gas analyzer 220, the MFC 230, the pressure sensor 240, the blowers 212, 208, and/or 204, and/or the stack 102. The system controller 225 may be configured to control various elements of the power module 100. For example, the system controller 225 may be configured to control fuel and/or air flow through the power module 100, according to fuel composition data received from the gas analyzer 220.

The MFC 230 may be configured to precisely control a fuel mass flow through the power module 100 to the stack 102. For example, the MFC 230 may include an electrically controlled valve, such as a proportional valve, and may also include a fuel flow rate sensor. The MFC 230 may be fluidly connected to the fuel conduit 300A. The pressure sensor 240 may be configured to monitor the fuel pressure in the fuel manifold 44 and/or in the fuel conduit 300A.

The gas analyzer 220 may be configured to analyze the composition of the fuel in the fuel manifold 44 and/or in the fuel conduit 300A that is output from the fuel processor 16. For example, the gas analyzer 220 may be configured to detect a hydrogen (H₂) content and hydrocarbon gas content of the fuel stream output from the fuel processor 16, in real time. In some embodiments, the gas analyzer 220 may be an optical gas composition detector. In some embodiments, the gas analyzer 220 may be a non-dispersive infrared (NDIR) gas analyzer. However, any suitable type of gas analyzer may be used.

In various embodiments, the gas analyzer 220 may continuously detect the fuel composition. In the alternative, the gas analyzer 220 may periodically detect the fuel composition. For example, the gas analyzer 220 may detect the fuel composition every second, every ten seconds, or every minute.

The system controller 225 may be configured to calculate a gas correction factor (GCF) based on real time gas composition data received from the gas analyzer 220 and/or fuel pressure data received from the pressure sensor 240. The system controller 225 may be configured to control a fuel mass flow rate of the MFC 230 based on the composition of the fuel and/or a voltage/current output by the stack 102.

For example, the system controller 225 may be configured to increase a fuel mass flow rate of the MFC 230, if the hydrogen to hydrocarbon ratio of the fuel increases. If the hydrogen to hydrocarbon ratio of the fuel decreases, the system controller 225 may be configured to decrease the fuel mass flow rate of the MFC 230. As such, the system controller 225 may be configured to provide a high system fuel utilization rate and/or prevent fuel starvation in the stack 102, even if the composition of the fuel changes. In addition, the system controller 225 may allow for the power module 100 to smoothly transition between hydrocarbon fuel and hydrogen operations, in real time.

In certain embodiments, the gas analyzer 220 may be configured to detect only a portion of the chemical components of the incoming fuel. In such situations, the system controller 225 may be configured to determine the full composition of the incoming gas by extrapolation from data generated by the gas analyzer 220 in combination with composition data received from another data source (e.g., from a gas supplier). In another embodiment, the quality of the incoming fuel may be measured using the gas analyzer 220 data. For example, the gas analyzer 220 may be used to determine if the incoming fuel suffers from a “quality” event (e.g., the fuel composition changes or the fuel is contaminated with impurities).

In some embodiments, the system controller 225 may be configured to control one or more fuel cell stacks 102 and/or systems at a given site (e.g., by increasing or decreasing an amount of fuel using a valve in the fuel inlet 40, and/or by increasing or decreasing a stack output voltage or current, and/or by adjusting the speed of a fuel recycle blower 212 to control fuel utilization).

The system controller 225 may also use other feedback signals to determine the desired fuel flow rate, such as stack voltage and the temperature of the ATO 130, in order to detect and/or respond to changes in fuel composition. For example, a reduction in the temperature of the ATO 130 and/or a reduction in the fuel cell stack 102 output voltage may indicate that the stack 102 is starved for fuel. If the fuel flow rate is too high, the temperature of the ATO 130 may rise above a normal operating temperature and/or the stack output voltage may also experience a similar increase.

In some embodiments, the system controller 225 may be configured to provide system data, such as fuel composition and/or fuel utilization rates to a central location or processing device. For example, the system controller may be connected to the Internet via the telemetry module 35, which may allow for monitoring and/or control of multiple fuel cell systems 10, regardless of location.

Accordingly, the fuel cell system 10 may provide a dual fuel capability, allowing for operation using either a hydrocarbon fuel (e.g., natural gas, etc.) or hydrogen (H₂) fuel. The MFC calibration may be adjusted during fuel type switching to maintain accurate fuel flow control. In some embodiments, the fuel processor 16 may operate to buffer fuel composition changes by adsorbing and/or desorbing hydrogen. Accordingly, locating the gas analyzer 220 downstream of the fuel processor 16 may provide more accurate fuel composition data and improve fuel utilization efficiency.

The system 10 may be configured to utilize gas composition data to detect the completion of a fuel transition, and the system controller 225 may be configured to adjust a MFC calibration table, while fuel cell output voltages of the stack 102 are monitored to prevent fuel starvation. Once the fuel transition is complete and the gas output of the fuel processor 16 has switched to 100% of one fuel type, the system 10 may return to steady-state operation (e.g., operation on single fuel type). In one embodiment, the fuel transition may comprise a natural gas utility either increasing or decreasing the amount of hydrogen being added to natural gas provided to the fuel inlet 40 from a natural gas pipeline.

In some embodiments, the system controller 225 may be configured to control one or more fuel cell stacks 102 and/or systems at a given site by increasing or decreasing an amount of fuel provided to the stacks 102 using the MFC 230, by increasing or decreasing a stack output voltage or current, and/or by adjusting the speed of the fuel recycle blower 212, to control fuel utilization based on the detected fuel composition.

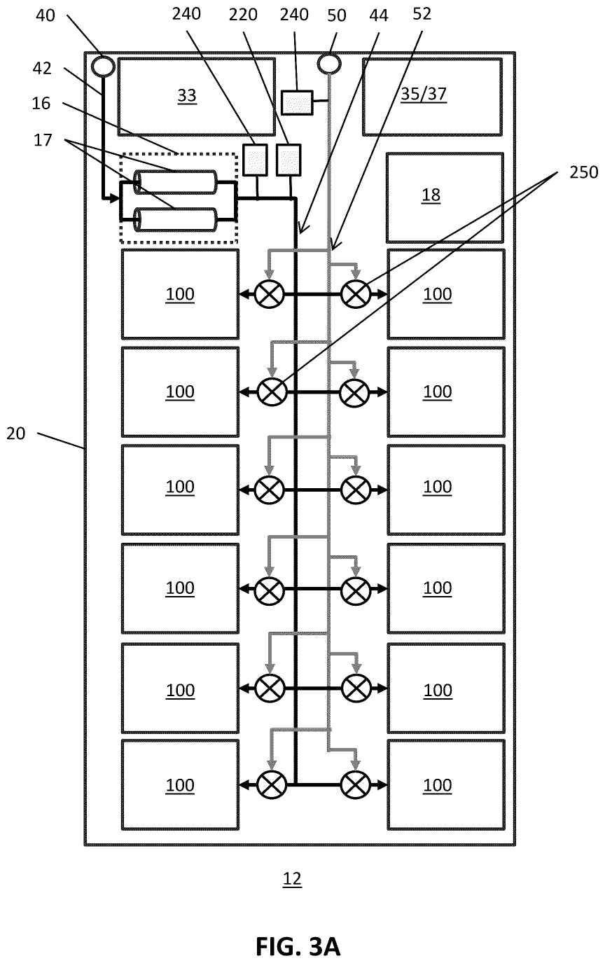

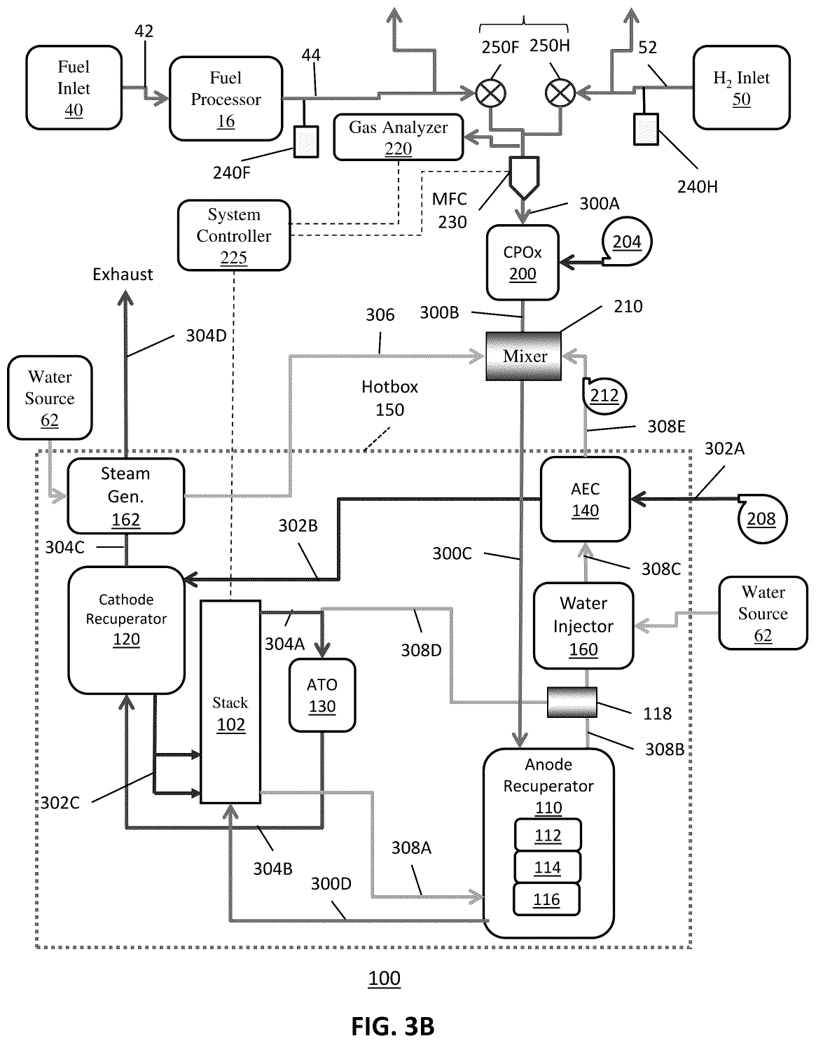

FIG. 3A is a schematic view showing fuel flow through an alternative fuel cell system 12, according to various embodiments of the present disclosure. FIG. 3B is a schematic view showing components of and connections to a power module 100 of FIG. 3A. The fuel cell system 12 may be similar to the fuel cell system 10 of FIGS. 1-2B. As such, only the differences therebetween will be described in detail.

Referring to FIGS. 3A and 3B, the fuel cell system 12 may be configured to operate using fuels provided from different fuel sources. In particular, the system 12 may be configured to blend and/or transition between a hydrocarbon fuel (e.g., natural gas or methane) and hydrogen (H₂) on a site level, based on the availability of hydrogen and/or natural gas. In some embodiments, the fuel cell system 12 may be configured to utilize available hydrogen (H₂) in order to reduce carbon emissions.

The fuel cell system 12 may include a fuel inlet 40 and a hydrogen inlet 50. The fuel inlet 40 may be fluidly connected to a hydrocarbon fuel source, such as a natural gas line. The hydrogen inlet 50 may be a hydrogen inlet fluidly connected to a hydrogen (H₂) source, such as a hydrogen tank, a hydrogen supply line, a hydrogen fuel processor or an electrolyzer system. For example, in some embodiments, hydrogen may be extracted from fuel cell anode exhaust and then stored and/or provided to the hydrogen inlet 50. In other embodiments, the hydrogen may be produced on site, for example by an electrolyzer system, or may be provided from elsewhere and stored on site.

The hydrogen inlet 50 may be connected to the power modules 100 by a hydrogen manifold 52 (e.g., one or more hydrogen conduits). The hydrogen manifold 52 may be at least partially contained in the base 20. The fuel cell system 12 may include pressure sensors 240 (e.g., 240F, 240H as shown in FIG. 3B) configured to respectively determine a fuel pressure in the fuel manifold 44 and a hydrogen pressure in the hydrogen manifold 52.

The fuel cell system 12 may include fuel valves 250, such as electrically operated proportionate valves (e.g., solenoid valves), configured to control natural gas and hydrogen flow to each of the power modules. As shown in FIG. 3A, one fuel valve 250, such as a three-way valve, may be used to control natural gas and hydrogen flow to each power module 100. However, as shown in FIG. 3B, the fuel valves 250 may include separate hydrocarbon fuel valves 250F and hydrogen valves 250H, to respectively control a hydrocarbon fuel (e.g., natural gas or methane) and hydrogen flow to each power module 100 from the respective manifolds 44, 52.

In one embodiment, the fuel cell system 12 may utilize the fuel valves 250 as an ON/OFF switching mechanism between hydrogen and hydrocarbon fuel. In this embodiment, the hydrocarbon fuel is maintained at a lower pressure than the hydrogen fuel. Thus, the fuel cell system 12 switches to hydrocarbon fuel if the hydrogen fuel pressure drops below a certain threshold pressure (e.g. hydrogen manifold 52 pressure may be set to 15 psi while the fuel manifold 44 pressure may be regulated to 13 psi). If the hydrogen pressure sensor 240H detects that the hydrogen fuel pressure is below a threshold pressure, then the fuel cell system 12 utilizes the fuel valves 250 to switch from hydrogen fuel to hydrocarbon fuel independently of the system controller 225 decision. Specifically, the fuel valve 250F is opened and the hydrogen valve 250H is closed to supply the fuel cell stack(s) 102 with the hydrocarbon fuel instead of the hydrogen fuel. In one embodiment, this fuel valve 250 operation to switch from hydrogen to hydrocarbon fuel would solely respond to specific events of hydrogen fuel pressure dropping below a threshold. In one embodiment, the system controller 225 can pick up the fuel switching event by monitoring the pressure threshold(s) and also using the gas analyzer 220.

The fuel cell system 12 may include a system controller 225 configured to control operation of the system 12. For example, the system controller 225 may be configured to control operation of the fuel valves 250 based on natural gas and hydrogen pressure data that may be continuously or periodically generated by the pressure sensors 240. Accordingly, the system 12 may be configured to operate using a hydrocarbon fuel (e.g., natural gas), hydrogen, or a blend of hydrocarbon and hydrogen fuels.

For example, based on the detected hydrogen pressure, the system controller 225 may be configured to operate the fuel valves 250, such that a number of the power modules 100 are fueled with hydrogen, while a remainder of the power modules are fueled with natural gas. In particular, the number of power modules fueled by hydrogen may be based on an amount of available hydrogen, as determined by the hydrogen pressure data. Alternatively, all power modules 100 may be operated on a blend of hydrocarbon fuel and hydrogen provided from separate respective inlets 40, 50.

The system controller 225 may also control the MFC 230 of each power module 100, based on the type of fuel provided thereto. For example, the system controller 225 may be configured such that power modules 100 receiving hydrogen fuel have a higher fuel mass flow than power modules receiving a higher power density hydrocarbon fuel, such as natural gas or methane. Alternatively, the system controller 225 may be configured to increase a blended hydrocarbon and hydrogen fuel mass flow rate if the hydrogen to natural gas ratio in the blended fuel increases, and vice-versa.

In other embodiments, the system controller 225 may be configured to control one or more fuel cell stacks 102 and/or power modules 100 at a given site (e.g., by increasing or decreasing fuel mass flow to the power modules 100 using a valve (e.g., MFC 230), and/or by increasing or decreasing a stack output voltage or current, and/or by adjusting the speed of a fuel recycle blower 212 to control fuel utilization).

In some embodiments, the fuel cell system 12 may optionally include a gas analyzer 220 to detect a composition of the fuel provided to the power modules 100. The gas analyzer 220 may comprise a gas analyzer located on the hydrocarbon fuel manifold 44, as shown in FIG. 3A. Alternatively, the gas analyzer 220 may be located on the fuel conduit downstream of the fuel valve(s) 250 and upstream of the MFC 230, as shown in FIG. 3B. In particular, the fuel cell system 12 may be configured to provide at least some of the power modules 100 with a blended hydrocarbon/hydrogen fuel received from a utility gas line and control a fuel mass flow and/or operation of the power modules 100 based on the composition of the blended fuel.

In one embodiment, the desulfurization adsorption beds 17 are used as buffer tanks to mitigate immediate fuel concentration changes. In this embodiment, the fuel processor 16 containing the adsorption beds 17 is located the fuel conduit 300A instead of on the fuel manifold 44. Thus, the fuel processor 16 is located downstream of the fuel valves 250 and downstream from the point where the hydrogen manifold 52 is connected to the fuel manifold 44. Therefore, both the hydrogen fuel and the hydrocarbon fuel (e.g., a gas mixture of these fuels) pass through the adsorption beds 17 in the fuel processor 16. In this embodiment, the system controller 225 is provided with information regarding timing of different gas species (e.g., hydrogen and hydrocarbon) in the gas mixture passing through desulfurization adsorption beds 17, and determines the time it takes before fuel composition changes are detected on the outlet side of the fuel processor 16. In one embodiment, the gas analyzer 220 may be located at the outlet of the adsorption beds 17 in the fuel processor 16. Mixing hydrogen and hydrocarbon fuel upstream of the adsorption beds is beneficial because it permits the system controller 225 time to react various events (e.g., fuel composition or concentration changes, etc.).

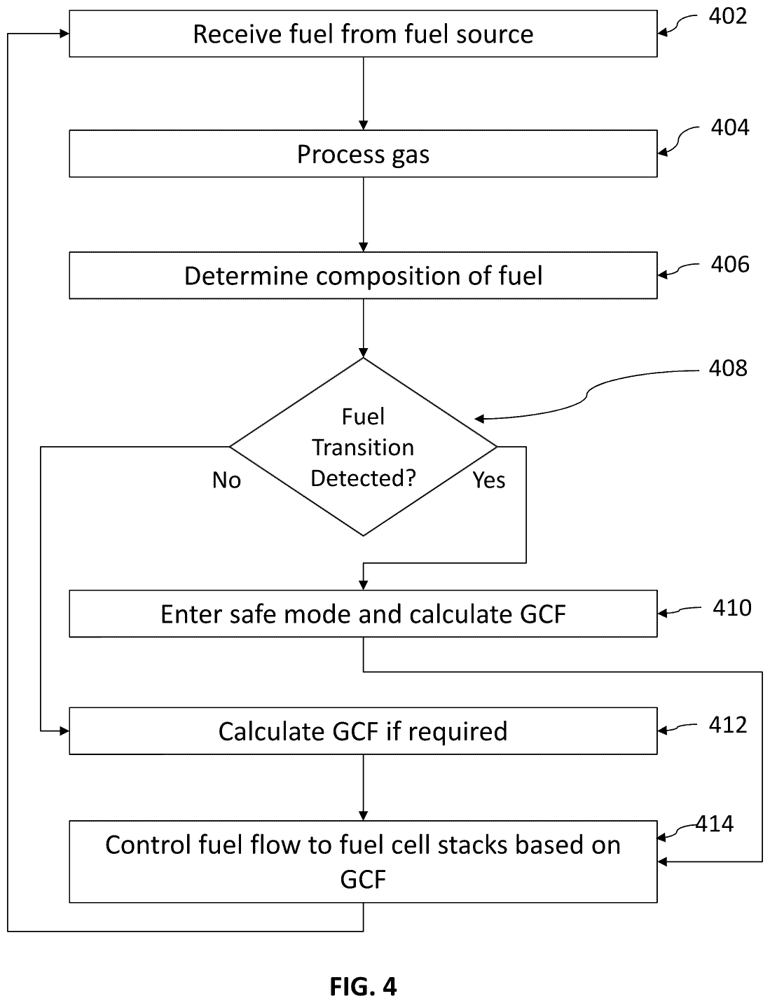

FIG. 4 is a flow chart illustrating a method of controlling a fuel cell system, according to various embodiments. In various embodiments, the method may be performed using a fuel cell system 10 as shown in FIGS. 2A-2B.

Referring to FIGS. 2A, 2B, and 4, in operation 402, the method may include receiving fuel from a fuel source, such as a fuel utility at the fuel inlet 40. The fuel may be a hydrocarbon fuel (e.g., natural gas, methane, etc.), hydrogen (H₂), or a blended fuel containing a hydrocarbon fuel and hydrogen (H₂).

In operation 404, the fuel may be provided to the fuel processor 16 and processed. For example, the fuel may be provided to the adsorption beds 17 to remove sulfur species and/or other contaminants from the natural gas. In various embodiments, operations 402 and 404 may continuously occur during steady-state operation of the fuel cell system 10.

In operation 406, the composition of the fuel output from the fuel processor 16 may be determined using the gas analyzer 220. For example, the gas analyzer 220 may be configured to determine the hydrogen (H₂) content and hydrocarbon content of the fuel output from the fuel processor 16. Fuel composition data generated by the gas analyzer 220 may be output to the system controller 225. In some embodiments, the gas analyzer 16 and/or the system controller 225 may calculate a hydrogen to hydrocarbon mass or volume ratio, such as a hydrogen gas to natural gas mass or volume ratio, of the fuel output from the fuel processor 16.

In operation 408, the system controller 225 may determine whether a fuel transition has occurred or is in process. In particular, the system controller 225 may determine whether the fuel supplied to the fuel cell system 10 has changed from a first fuel to a second fuel (e.g., from a hydrocarbon fuel to hydrogen, from hydrogen to a hydrocarbon fuel, from a blended fuel to hydrogen or a hydrocarbon fuel (or vice versa), or if a hydrogen to hydrocarbon fuel ratio in the blended fuel has changed). During a fuel transition from a first fuel to a second fuel, some amount of the first fuel may remain in the fuel conduits and/or the fuel processor 16 for a fuel transition period. As such, some amount of the first fuel may continue to be supplied to the stacks 102 during the fuel transition period. During the fuel transition period, the amount of the first fuel in the system 10 may decrease relatively rapidly.

The system controller 225 may be configured to determine whether a fuel transition has occurred or is in process, or a fluctuation in the composition of a blended fuel has occurred without a fuel transition. For example, the system controller 225 may detect a fuel transition when a ratio of a detected amount of a first fuel to second fuel changes by an amount that exceeds a set change amount limit.

In one embodiment, a fuel ratio change that exceeds the change amount limit may indicate that a fuel being supplied to the fuel inlet 40 is transitioning from a first fuel to a second fuel. In other words, during the fuel transition period, the fuel supplied to the stacks 102 may change from natural gas to hydrogen, from hydrogen to natural gas, from a blended fuel to only hydrogen or natural gas (or vice versa), or that a different composition blended fuel is being provided. However, during a transition period, both the first and second fuel may be supplied to the stacks 102, due to residual amounts of the first fuel in the system 10, such as in the fuel processing module.

If a fuel transition is detected, the method may proceed to operation 410. If no fuel transition is detected, the method may proceed to operation 412.

In operation 410, the system controller 225 may control the system 10 to enter a safe mode during the fuel transition period. During the safe mode, the fuel cell stacks 102 operate at a reduced output voltage to protect the stacks 102 from fuel starvation. Operation 410 may also include calculating a gas correction factor (GCF) based on the fuel composition data. In some embodiments, stack output voltages and/or currents may be utilized by the system controller 225 to determine a fuel mass flow rate that prevents fuel starvation in each power module 100 during the safe mode. The system 10 may exit the safe mode after the GCF has been calculated and the transition period expires (e.g., only one type of fuel is provided to the stacks 102) and return to steady-state operation. In some embodiments, the GCF may be calculated at the end of the transition period. The method may proceed to operation 414.

In operation 412, the system controller 225 may calculate a GCF based on the fuel composition data. For example, a GCF may be calculated if a small change in composition of the blended fuel that is less than the set change amount limit is detected. After the GCF is calculated, the method may proceed to operation 414. If no fuel composition change is detected, the method may proceed to operation 414 without performing a GCF calculation and utilize an existing GCF instead.

In operation 414, fuel may be provided to the fuel cell stacks 102 based on the GCF. In particular, the system controller 225 may then control the MFC 230 based on the calculated GCF, in order to provide fuel to the stacks 102 at a mass flow rate that corresponds to the fuel composition. For example, the system controller 225 may be configured to provide a relatively high fuel mass flow rate for fuels having a relatively high hydrogen to hydrocarbon gas mass ratio (e.g., hydrogen gas to natural gas mass or volume ratio). The system controller 225 may also be configured to provide a relatively low fuel mass flow rate for fuels having a relatively low hydrogen to hydrocarbon mass ratio (e.g., hydrogen gas to natural gas mass or volume ratio).

The method may then return to operation 402. Accordingly, the gas analyzer 220 may determine the fuel composition continuously or periodically and output corresponding fuel composition data to the system controller 225. In addition, the fuel mass flow rate may be continuously or periodically adjusted in real time, based on the composition of the fuel provided to the fuel cell system 10. As such, the method may modify a fuel mass flow rate in real time, based on the composition of a received fuel, in order to provide a high fuel utilization rate and/or to prevent fuel starvation. As such, the method may allow a fuel cell system to operate using a hydrocarbon fuel, a hydrogen fuel, or blended fuel including hydrogen and hydrocarbon fuel.

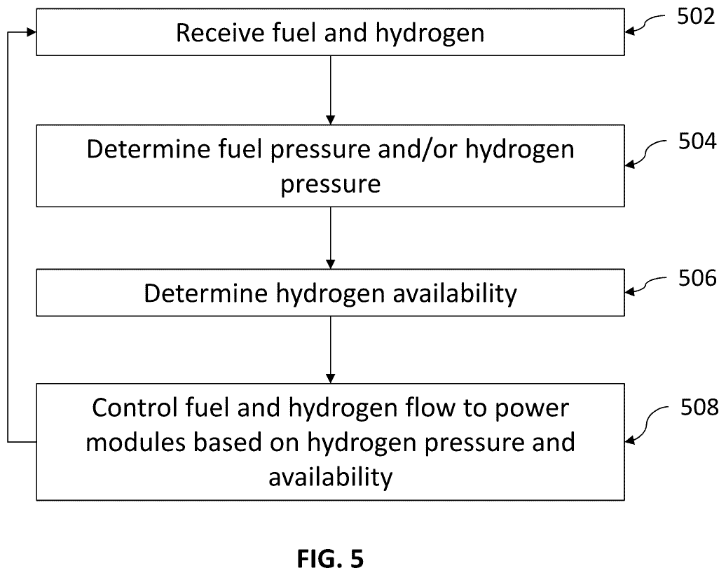

FIG. 5 is a flow chart illustrating various operations of a method of controlling a fuel cell system, according to various embodiments. In various embodiments, the method may be performed using a fuel cell system 12 as shown in FIGS. 3A-3B.

Referring to FIGS. 3A, 3B, and 5, in operation 502, the system 12 may be provided with a fuel from a fuel source, such as a fuel utility, at the fuel inlet 40. The fuel may be a hydrocarbon fuel (e.g., natural gas, methane, etc.), or a blended fuel containing a natural gas and hydrogen (H₂). The system 12 may also be provided with hydrogen at the hydrogen inlet 50.

In operation 504, fuel pressure and hydrogen gas pressure may be determined. For example, the pressure sensors 240 may include the hydrogen pressure sensor 240H configured to detect a hydrogen gas pressure in hydrogen manifold 52 and the fuel pressure sensor 240F configured to detect a fuel pressure in fuel manifold 44.

In operation 506, an amount of available hydrogen may be determined based on the detected hydrogen gas pressure. For example, if hydrogen is being continuously produced and/or supplied, the hydrogen gas pressure may be used to determine an amount of hydrogen that is available for use. If the hydrogen is stored in a hydrogen tank, the volume of the tank and the hydrogen pressure may both be used to determine the hydrogen availability.

In operation 508, fuel and hydrogen flow to the power modules 100 may be determined. In particular, the system controller 225 may be configured to determine the number of power modules 100 that may be provided with hydrogen, based on the determined hydrogen pressure and availability. For example, the system controller 225 may control the operation of the fuel valves 250, such that some or all of the power modules 100 are operated using hydrogen. In some embodiments, when an amount of available hydrogen is less than the fuel requirement of the system 12, the system controller 225 may provide hydrogen to a subset of the power modules 100 and may provide the fuel to a remainder of the power modules. Alternatively, the system controller 225 may control the MFCs 230 to provide a blended hydrogen and hydrocarbon fuel having the same or different hydrogen to hydrocarbon fuel ratios to the power modules 100.

In some embodiments, the system controller 225 may be configured to determine a GCF for the subset of the power modules 100 provided with hydrogen or a blended fuel, as described above with respect to the method of FIG. 4. For example, the system controller 225 may operate the subset of power modules 100 in the safe mode during a fuel transition period during which the GCF may be calculated.

The method may then return to operation 502. In particular, operation 502 may occur continuously during steady-state operation of the system 12, and the hydrogen availability may be determined periodically or continuously. For example, if hydrogen availability decreases, one or more of the power modules 100 being provided with hydrogen may be transitioned back to operating using the fuel provided to the fuel inlet 40, or the blended fuel may include a decreased hydrogen to hydrocarbon fuel ratio.

In some embodiments, operation 506 may include providing both fuel and hydrogen to one or more of the power modules 100. In particular, a blended fuel may be generated on site by mixing the fuel and the hydrogen, and the blended fuel may be provided to one or more of the power modules 100 based on the hydrogen availability.

The preceding description of the disclosed aspects is provided to enable any person skilled in the art to make or use the present disclosure. Various modifications to these aspects will be readily apparent to those skilled in the art, and the generic principles defined herein may be applied to other aspects without departing from the scope of the disclosure. Thus, the present disclosure is not intended to be limited to the aspects shown herein but is to be accorded the widest scope consistent with the principles and novel features disclosed herein.

1. A fuel cell system, comprising:
a fuel inlet configured to receive a fuel from a fuel source;
a fuel processor configured to remove contaminants from the fuel provided to the fuel inlet;
a gas analyzer configured to detect fuel composition of the fuel output from the fuel processor;
a stack of fuel cells configured to generate electricity using the fuel output from the fuel processor;
a mass flow controller (MFC) configured to control a mass flow rate of the fuel output from the fuel processor to the stack; and
a system controller configured to control the MFC based on the detected fuel composition.

2. The system of claim 1, wherein the detected fuel composition comprises a hydrogen and hydrocarbon content of the fuel, and the fuel comprises a blended fuel comprising a hydrocarbon gas and a hydrogen gas.

3. The system of claim 2, wherein the system controller is further configured to:
determine whether the hydrogen to the hydrocarbon ratio of the fuel gas changes by an amount that exceeds a set change amount limit;
increase the fuel mass flow rate if the fuel composition indicates an increase in the hydrogen to hydrocarbon ratio of the fuel output from the fuel processor; and
decrease the fuel mass flow rate if the fuel composition indicates a decrease in the hydrogen to the hydrocarbon ratio of the fuel output from the fuel processor.

4. The system of claim 1, wherein:
the system controller is further configured to calculate a gas correction factor if the detected fuel composition indicates a change in fuel composition;
the system controller is further configured to control the stack to operate in a safe mode if the system controller determines that the fuel transition is in process, the fuel transition comprising a change in the fuel that is supplied from the fuel source from a first fuel to a second fuel; and
the safe mode comprises operating the stack at a reduced output voltage or current until the fuel transition is complete based on a calculated gas correction factor.

5. The system of claim 1, wherein:
the fuel processor comprises a desulfurizer;
the gas analyzer is fluidly connected to a fuel conduit that fluidly connects the fuel processor to the MFC; and
the fuel cells comprise solid oxide fuel cells.

6. The system of claim 1, further comprising:
a fuel manifold fluidly connecting the fuel processor to the stack;
a hydrogen inlet configured to receive hydrogen from a hydrogen source; and
a hydrogen manifold fluidly connecting the hydrogen inlet to the stack.

7. The system of claim 6, wherein the fuel processor comprises at least one desulfurizer adsorption bed located on a fuel conduit downstream of a point at which the fuel manifold and the hydrogen manifold are connected to the fuel conduit.

8. The system of claim 6, further comprising:
at least one fuel valve configured to control the fuel flow from the fuel manifold and the hydrogen flow from the hydrogen manifold to the stack; and
a hydrogen pressure sensor configured to detect a hydrogen pressure in the hydrogen manifold, wherein the system controller is further configured to control the at least one fuel valve based on the detected hydrogen pressure.

9. The fuel cell system of claim 8, further comprising power modules comprising stacks of fuel cells, wherein:
the system controller is further configured to control the at least one fuel valve such that the hydrogen is provided to a first set of the power modules, based on the detected hydrogen pressure, and the fuel is provided to a remainder of the power modules;
each of the power modules comprises a respective mass flow controller; and
the fuel manifold and the hydrogen manifold are embedded in base supporting the fuel processor and the power modules.

10. The fuel cell system of claim 8, wherein the at least one fuel valve is configured to turn off the hydrogen flow from the hydrogen manifold and to turn on the fuel flow from the fuel manifold in response to a hydrogen pressure dropping below a threshold pressure.

11. A method of operating a fuel cell system, comprising:
providing a fuel to a fuel cell system;
purifying the fuel to generate a purified fuel;
detecting a fuel composition of purified fuel;
determining a fuel mass flow rate of the purified fuel based on the detected fuel composition; and
providing the purified fuel to a stack of fuel cells at the determined mass flow rate.

12. The method of claim 11, further comprising:
determining if a fuel transition is occurring based on the detected fuel composition;
operating the stack in a safe mode at a reduced output voltage or current until the fuel transition is complete based on the detected fuel composition; and
operating the stack in a steady state mode at an increased output voltage or current greater than the safe mode output voltage or current after the fuel transition is complete.

13. The method of claim 12, wherein:
the purified fuel comprises a blended hydrogen and desulfurized hydrocarbon fuel;
the detecting the fuel composition of the purified fuel comprising detecting the hydrogen content and the hydrocarbon fuel content of the blended hydrogen and desulfurized hydrocarbon fuel; and
the determining the fuel mass flow rate further comprises calculating a gas correction factor based on the detected hydrogen content and the hydrocarbon fuel content.

14. The method of claim 13, wherein:
the determining if the fuel transition is occurring is based on if the hydrogen to hydrocarbon gas ratio of the blended fuel changes by the amount that exceeds a set change amount limit; and
the operating the stack in the safe mode until the fuel transition is complete is based on the calculated gas correction factor.

15. The method of claim 11, further comprising:
increasing the fuel mass flow rate if the detected fuel composition indicates an increase in a hydrogen to hydrocarbon ratio of the fuel; and
decreasing the fuel mass flow rate if the detected fuel composition indicates a decrease in the hydrogen to the hydrocarbon ratio of the fuel.

16. The method of claim 11, wherein:
the fuel cell system comprises a plurality of power modules;
each of the plurality of the power modules comprises a plurality of the stacks of fuel cells; and
the purified fuel comprises a desulfurized natural gas.

17. The method of claim 16, further comprising:
providing hydrogen from a hydrogen source to the fuel cell system;
determining a pressure and availability of the hydrogen; and
controlling the flow rate of the desulfurized natural gas and the hydrogen to the plurality of power modules based on the pressure and availability of the hydrogen.

18. The method of claim 17, wherein the controlling the flow rate of the desulfurized natural gas and the hydrogen to the plurality of power modules comprises providing the hydrogen to a first set of the plurality of the power modules, and providing the desulfurized natural gas to a remainder of the plurality of the power modules.

19. The method of claim 11, wherein the detecting the fuel composition of the purified fuel comprises using a gas analyzer to detect a hydrogen to hydrocarbon ratio of the purified fuel.

20. The method of claim 19, wherein the providing the purified fuel to the stack of fuel cells at the determined mass flow rate comprises using a mass flow controller to control the mass flow rate of the purified fuel based on the detected hydrogen to hydrocarbon ratio of the purified fuel.

21. The method of claim 11, further comprising:
providing hydrogen from a hydrogen source to the fuel cell system;
determining a pressure of the hydrogen; and
stopping providing the hydrogen to the fuel cell system and providing the desulfurized natural gas to the fuel cell system in response to the pressure of the hydrogen dropping below a threshold pressure.

22. The method of claim 11, further comprising:
mixing a hydrocarbon fuel and a hydrogen fuel to provide the fuel; and
purifying the fuel by passing the fuel through at least one desulfurizer adsorption bed to generate the purified fuel.
